(19) United States
(12) Patent Application Publication
(10) Pub. No.: US 2020/0226379 A1
(43) Pub. Date: Jul. 16, 2020

(54) COMPUTER SYSTEM, PAVILION CONTENT CHANGING METHOD AND PROGRAM

(71) Applicant: OPTIM CORPORATION, Saga (JP)

(72) Inventor: Shunji SUGAYA, Tokyo (JP)

(21) Appl. No.: 16/617,267

(22) PCT Filed: May 26, 2017
(86) PCT No.: PCT/JP2017/019763

§ 371 Date: Feb. 24, 2020

(51) Int. Cl. G06K 9/00

(52) U.S. Cl. CPC G06K 9/00671; G06K 9/00302; G06K 9/00288

(57) ABSTRACT

A pavilion content changing method and program. The computer system includes: an acquisition unit, which is configured to acquire the attribute of the visitor; a selection unit, which is configured to select the content according to an attribute of the content and the attribute of the visitor; a display unit, which is configured to display the selected content at a venue of the pavilion; a determination unit, which is configured to determine whether the displayed content is popular; and a change unit, which is configured to: in response to determining that the displayed content is not popular, change to displaying content different from the displayed content associated with the corresponding attribute.

### TECHNICAL FIELD

The present disclosure relates to a computer system, and a pavilion content changing method and program, where the content is changed according to an attribute of a visitor in a pavilion.

### BACKGROUND

In recent years, various contents have been displayed at the pavilion to visitors. For example, in each booth configured in the pavilion venue, the content corresponding to each booth is displayed.

A configuration for displaying content different from the displayed content in a pavilion to a viewer, for example, a configuration for selecting content to be displayed based on attribute data of the viewer has been disclosed (Patent Document 1). In this configuration, content is displayed on a display provided in a specific apartment house based on attribute data of a resident who lives in the apartment house.

### LITERATURE IN THE RELATED ART

### Patent Document

Patent Document 1: Japanese Patent Publication No. JP2015-185139

### SUMMARY

### Problems to be Solved by the Present Disclosure

However, in the past, the content displayed in the pavilion had no relationship with the attribute (e.g., age, occupation, gender, and the number of persons) of the visitor. Moreover, the content may not always be of interest to the visitor. As a result, the content cannot be efficiently displayed to the visitor in the pavilion.

Further, even if the configuration of Patent Document 1 is applied when the content of the pavilion is displayed, the content to be displayed is merely changed based on the attribute data of each booth, and the content cannot be efficiently displayed to the visitor.

The present disclosure aims to provide a computer system, and a pavilion content changing method and program, with which the content can be efficiently displayed to the visitor in the pavilion.

### Solutions to the Problems

In the present disclosure, the following solutions are provided.

The present disclosure provides a computer system which changes content according to an attribute of a visitor in a pavilion. The computer system includes: an acquisition unit configured to acquire the attribute of the visitor; a selection unit configured to select the content according to the attribute; a display unit configured to display the selected content at a venue of the pavilion; a determination unit configured to determine whether the displayed content is popular; and a change unit configured to: in response to determining that the displayed content is not popular, change to displaying content different from the displayed content.

According to the present disclosure, the computer system for changing the content according to the attribute of the visitor of the pavilion acquires the attribute of the visitor, selects the content according to the attribute, displays the selected content at the venue of the pavilion, determines whether the displayed content is popular, and in response to determining that the displayed content is not popular, changes to displaying content different from the displayed content.

The present disclosure belongs to the field of computer systems, and also plays the same role and has the same effect corresponding to the field in other fields such as pavilion content changing methods and programs.

### Effects of the Present Disclosure

According to the present disclosure, the computer system, and the pavilion content changing method and program can be provided, and the content can be efficiently displayed to the visitor of the pavilion.

### BRIEF DESCRIPTION OF DRAWINGS

FIG. 1 is an overview of a pavilion content changing system 1.

FIG. 2 is a diagram of overall configuration of the pavilion content changing system 1.

FIG. 3 is functional block diagrams of a computer 10, an entrance terminal 100, and a content display 200.

FIG. 4 is a flowchart illustrating attribute acquisition processing performed by the computer 10 and the entrance terminal 100.

FIG. 5 is a flowchart illustrating content association processing performed by the computer 10.

FIG. 6 is a flowchart illustrating content display processing performed by the computer 10 and the content display 200.

FIG. 7 is a flowchart illustrating first content changing processing performed by the computer 10 and the content display 200.

FIG. 8 is a flowchart illustrating second content changing processing performed by the computer 10 and the content display 200.

### DETAILED DESCRIPTION

The best embodiment of the present disclosure will be described below with reference to the drawings. It should be noted that this is merely illustrative, and is not intended to limit the scope of the present disclosure.

### (Overview of a Pavilion Content Changing System 1)

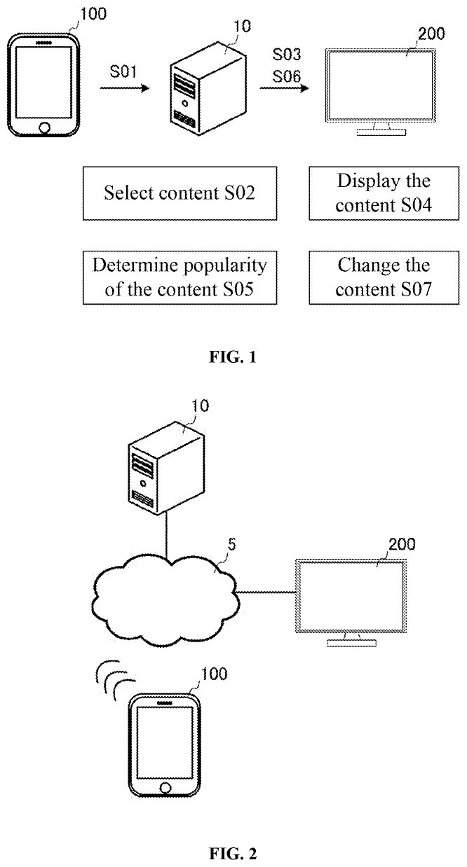

Based on FIG. 1, an overview of a preferred embodiment of the present disclosure is illustrated. FIG. 1 is an overview of the pavilion content changing system 1 according to the preferred embodiment of the present disclosure. The pavilion content changing system 1 is a computer system including a computer 10, an entrance terminal 100, and a content display 200 and changing content displayed on the content display 200 according to an attribute of a visitor in a pavilion.

It should be noted that in FIG. 1, the numbers of computers 10, entrance terminals 100, and content displays 200 may be appropriately changed. Further, the computer 10, the entrance terminal 100, and the content display 200 are not limited to actually existing apparatuses, and may also be virtual apparatuses. Further, the processing described below may also be implemented by a combination of any one or more of the computer 10, the entrance terminal 100, and the content display 200.

The computer 10 is a computer apparatus communicatively connected to the entrance terminal 100 and the content display 200. The computer 10 performs various processing such as image analysis, various calculations, and the like.

The entrance terminal 100 is a terminal apparatus communicatively connected to the computer 10 and the content display 200. The entrance terminal 100 is a terminal apparatus disposed at the door or a reception desk provided at a venue of a pavilion, and the like.

The content display 200 is a display apparatus communicatively connected to the computer 10 and the entrance terminal 200 and having a function of displaying content sent from the computer 10 and content stored by the content display 200 itself. The content displayed on the content display 200 is, for example, video and audio. It should be noted that the content display 200 may also be a portable terminal, a wearable terminal, or the like carried by the visitor.

The computer 10 acquires the attribute of the visitor (step S01). The attribute of the visitor refers to, for example, the gender, the age, the occupation, the address, the number of persons accompanying the visitor (in the case of a family, the number of family members; in the case of a group, the number of persons in the group, etc.), the birthplace, the field of interest, the number of viewers, the viewing time, and the expression. The computer 10 acquires the attribute from the following results: a preliminary questionnaire result (response result for each attribute) received from the visitor in advance; a questionnaire result received by the entrance terminal 100; and a result of image analysis (such as face recognition, age determination and number of accompanying persons determination) performed on an image of the visitor, where the image of the visitor is a moving or still image photographed by a photographing apparatus included by the entrance terminal 100.

The computer 10 selects, according to the acquired attribute, content to be displayed on the content display 200 (step S02). The computer 10 selects content suitable for the following attribute of the visitor, for example, the occupation, the age, whether to bring family members, the number of persons in a group, the birthplace, the field of interest, or the expression. At this point, the computer 10 selects content suitable for the visitor based on a combination of any one or more of these attributes.

The computer 10 sends the selected content to the content display 200 (step S03).

The content display 200 receives the content. The content display 200 displays the content based on the received content (step S04). The pavilion content changing system 1 displays the content on the content display 200 to display the content at the pavilion venue.

The computer 10 determines whether the content currently displayed on the content display 200 is popular (step S05).

For example, the content display 200 photographs a viewer who views the displayed content by using a photographing apparatus of the content display 200. The content display 200 photographs the viewer at regular intervals or all the time. The content display 200 sends the computer 10 image data obtained by photographing the viewer.

The computer 10 receives the viewer image data. The computer 10 performs image analysis on the viewer image data to calculate the viewing data indicating the number of viewers and the viewing time. The computer 10 calculates viewing time for each viewer included in the viewer image data. The calculation of the viewing time is performed, for example, in the following manner: the elapsed time is calculated from the time when a target viewer is first recognized to the time when the target viewer is no longer included in the viewer image data. Based on the calculated number of viewers and the viewing time, the computer 10 determines whether the content currently displayed on the content display 200 is popular. For example, the computer 10 determines that the content currently displayed on the content display 200 is popular when the number of viewers is greater than the predetermined number and the viewing time is longer than predetermined time, and determines that the content is not popular when the number of viewers is less than the predetermined number and the viewing time is shorter than the predetermined time.

In the case where the computer 10 determines that the content currently displayed on the content display 200 is not popular, the computer 10 selects content different from the content and sends the selected different content to the content display 200 (step S06). At this time, the computer 10 sends content different from the previously sent content corresponding to the above-mentioned attribute.

The content display 200 receives the content. The content display 200 changes the content to be displayed based on the content (step S07).

The above is the overview of the pavilion content changing system 1.

### (System Configuration of the Pavilion Content Changing System 1)

Based on FIG. 2, the system configuration of the pavilion content changing system 1 is described according to a preferred embodiment of the present disclosure. FIG. 2 is a diagram of system configuration of the pavilion content changing system 1 according to the preferred embodiment of the present disclosure. The pavilion content changing system 1 is a computer system including the computer 10, the entrance terminal 100, the content display 200, and a public wired network (Internet, third and fourth generation communication networks, etc.) 5 and changing the content displayed on the content display 200 according to an attribute of a visitor of a pavilion.

It should be noted that the numbers and types of various apparatuses constituting the pavilion content changing system 1 may be appropriately changed. In addition, the pavilion content changing system 1 is not limited to an actually existing apparatus, but may also be a virtual apparatus. In addition, the processing described below may also be implemented by a combination of any one or more of the apparatuses constituting the pavilion content changing system 1.

The computer 10 is the above-mentioned computer apparatus having the functions described below.

The entrance terminal 100 is the above-mentioned terminal apparatus having the functions described below.

The content display 200 is the above-mentioned display apparatus having the functions described below.

### (Description of Various Functions)

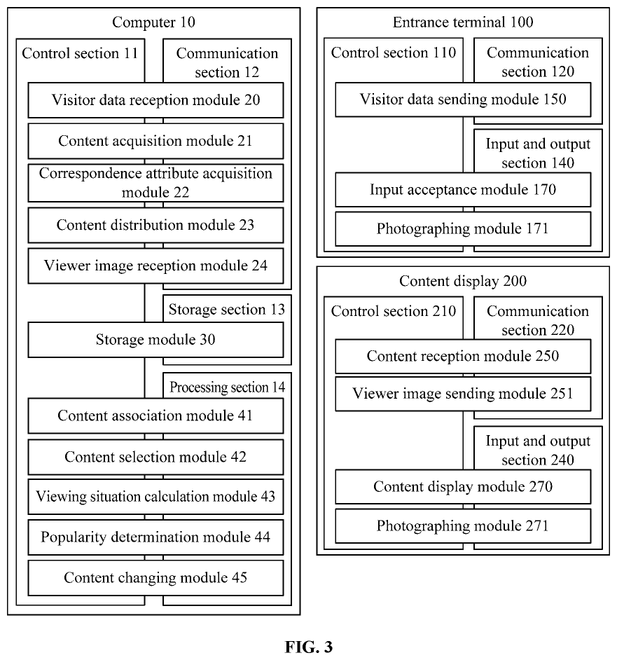

Based on FIG. 3, functions of the pavilion content changing system 1 are described according to a preferred embodiment of the present disclosure. FIG. 3 is a functional block diagram of the computer 10, the entrance terminal 100, and the content display 200.

The computer 10 includes a central processing unit (CPU), a random access memory (RAM), a read only memory (ROM) and the like as a control section 11, and a device for enabling communication with other equipment as a communication section 12, for example, a Wireless-Fidelity (Wi-Fi) compliant device or the like compliant with IEEE 802.11 is provided. In addition, the computer 10 is provided with a data storage section such as a hard disk, a semiconductor memory, a recording medium, a memory card, and the like as a storage section 13. In addition, the computer 10 is provided with various devices for performing various calculations, processing and the like as a processing section 14.

In the computer 10, when the control section 11 reads a predetermined program and cooperates with the communication section 12, a visitor data reception module 20, a content acquisition module 21, a correspondence attribute acquisition module 22, a content distribution module 23, and a viewer image reception module 24 are implemented. In addition, in the computer 10, when the control section 11 reads a predetermined program and cooperates with the storage section 13, a storage module 30 is implemented. In addition, in the computer 10, when the control section 11 reads a predetermined program and cooperates with the processing section 14, a face recognition module 40, a content association module 41, a content selection module 42, a viewing situation calculation module 43, a popularity determination module 44, and a content changing module 45 are implemented.

The entrance terminal 100, like the computer 10, is provided with a CPU, a RAM, a ROM, etc. as a control section 110, and a device for enabling communication with other equipment as a communication section 120. In addition, the entrance terminal 100 is provided with an input and output section 140 having a display section for outputting and displaying data and images controlled by the control section 110, an input section such as a touch panel, a keyboard and a mouse for accepting an input from a visitor, and various devices such as a photographing device for photographing the visitor.

In the entrance terminal 100, when the control section 110 reads a predetermined program and cooperates with the communication section 120, a visitor data sending module 150 is implemented. In addition, in the entrance terminal 100, when the control section 110 reads a predetermined program and cooperates with the input and output section 140, an input acceptance module 170 and a photographing module 171 are implemented.

The content display 200, like the entrance terminal 100, is provided with a CPU, a RAM, a ROM, and the like as a control section 210, a device for enabling communication with other equipment as a communication section 220, and a display section, an input section, and various devices such as a photographing device as an input and output section 240.

In the content display 200, when the control section 210 reads a predetermined program and cooperates with the communication section 220, a content reception module 250 and a viewer image sending module 251 are implemented. In addition, in the content display 200, when the control section 210 reads a predetermined program and cooperates with the input and output section 240, a content display module 270 and a photographing module 271 are implemented.

### (Attribute Acquisition Processing)

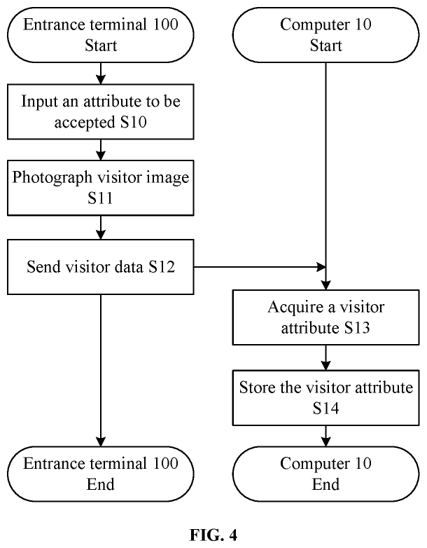

Based on FIG. 4, attribute acquisition processing performed by the pavilion content changing system 1 is described. FIG. 4 is a flowchart illustrating attribute acquisition processing performed by the computer 10 and the entrance terminal 100. Processing performed by the module of each device described above will be described together with the present processing. First, the input acceptance module 170 accepts an input of the attribute of a visitor (step S10). In step S10, the input acceptance module 170 accepts an input of a combination of one or more of gender, age, occupation, address, the number of accompanying persons (number of family members, number of persons in a group, etc.), birthplace, and preferences (fields of interest, hobbies, favorite items, etc.) as the attribute of the visitor.

The photographing module 171 photographs an image such as a moving image, a still image, and the like of the visitor as a visitor image (step S11). In step S11, the photographing module 171 photographs an image including the face of the visitor as the visitor image. The photographing module 171 photographs, for example, a visitor located close to the entrance terminal 100 as a group. The group may be one visitor or a plurality of visitors. The photographing module 171 photographs the entire family as a group in the case where the visitor brings the family. In addition, the photographing module 171 photographs the group of a plurality of persons as a group in the case where the visitors are the group of the plurality of persons. In addition, the photographing module 171 photographs a single person as a group in the case where the visitor is the single person.

It should be noted that the order of the processing of step S10 and step S11 may be changed appropriately.

The visitor data sending module 150 sends the above-mentioned visitor data indicating the visitor attribute, the visitor image, and the current date and time to the computer 10 (step S12).

The visitor data reception module 20 receives the visitor data. The face recognition module 40 performs face recognition of the visitor based on the received visitor data to acquire the attribute of the visitor (step S13). In step S13, the face recognition module 40 performs face recognition by performing image analysis on the visitor image. The face recognition module 40 acquires, for example, gender, age, the number of accompanying persons, and expression as the attribute of the visitor according to the result of performing face recognition. In addition, the visitor data reception module 20 acquires the attribute of the visitor whose input has been accepted included in the visitor data.

It should be noted that the processing of step S13 may also be performed by the entrance terminal 100 instead of the computer 10. In this case, the entrance terminal 100 sends the visitor data and the attribute of the visitor acquired according to the result of face recognition to the computer 10 as the visitor data.

The storage module 30 stores the visitor data and the attribute of the visitor acquired according to the result of face recognition (step S14). In step S14, the storage module 30 stores the attribute of the visitor, the visitor image, and the current date and time in association with each other.

The above is the attribute acquisition processing.

It should be noted that the pavilion content changing system 1 may also acquire the attribute of the visitor at a timing other than the time of entry. For example, the pavilion content changing system 1 may also acquire the attribute of the visitor in a form such as a preliminary questionnaire using a terminal apparatus or the like owned by the visitor. In this case, the visitor inputs the date and time of visit and the above-mentioned attribute as a preliminary questionnaire, and the pavilion content changing system 1 acquires the preliminary questionnaire having accepted the input. Specifically, the visitor accesses a website or the like of the pavilion via a terminal apparatus or the like, and inputs the date and time of visit and the attribute. The computer 10 acquires the date and time of visit and the attribute in the input that has been accepted.

### (Content Association Processing)

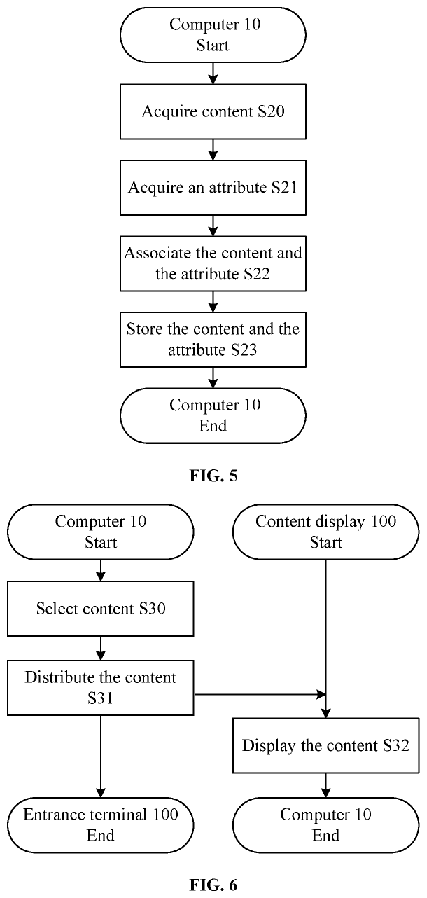

Based on FIG. 5, the content association processing performed by the pavilion content changing system 1 is described. FIG. 5 is a flowchart illustrating content association processing performed by the computer 10. Processing performed by each module described above will be described together with the present processing.

First, the content acquisition module 21 acquires the content (step S20). In step S20, the content acquisition module 21 acquires content to be displayed on the content display 200 from a terminal apparatus of an exhibitor or an operator who exhibits the content. For example, the content acquisition module 21 acquires content by receiving content sent by the exhibitor's computer. In addition, for example, the content acquisition module 21 acquires content from a connected auxiliary storage apparatus (USB memory, SD memory card, etc.) of the exhibitor.

The correspondence attribute acquisition module 22 acquires an attribute corresponding to the acquired content (step S21). In step S21, the correspondence attribute acquisition module 22 acquires an attribute for displaying the content acquired from the terminal apparatus of the exhibitor or the operator. The attribute is the attribute of the visitor described above.

The content association module 41 associates the acquired content with an attribute corresponding to the content (step S22). In step S22, for example, the content association module 41 associates the attribute of an agricultural high school student with content related to artificial intelligence (AI)/Internet of Things (IoT) in the agricultural field.

The storage module 30 stores the content and the attribute corresponding to the content in association with each other (step S23).

The above is the content association processing.

It should be noted that the above-mentioned content association processing may be performed before or during exhibition in the pavilion. In addition, the exhibitor or the operator may set the attribute corresponding to each content in advance to omit the present processing.

### (Content Display Processing)

Based on FIG. 6, the content display processing performed by the pavilion content changing system 1 is described. FIG. 6 is a flowchart illustrating content display processing performed by the computer 10 and the content display 200. Processing performed by the module of each apparatus described above will be described together with the present processing.

The content selection module 42 selects content to be displayed on the content display 200 based on the visitor data stored in the storage module 30 (step S30). In step S30, the content selection module 42 selects content suitable for the current visitor. The content selection module 42 refers to the attribute associated with the content based on the stored visitor attribute. The content selection module 42 selects the content corresponding to the attribute of the visitor as the content to be displayed on the content display 200 this time.

In the case where a predetermined attribute exists, the content selection module 42 may select content corresponding to the predetermined attribute. For example, the content selection module 42 selects content suitable for the occupation of the visitor. In addition, the content selection module 42 selects content suitable for the age of the visitor. In addition, the content selection module 42 selects content suitable for family members brought by the visitor. In addition, the content selection module 42 selects content suitable for the number of visitors in a group. In addition, the content selection module 42 selects content suitable for the birthplace of the visitor. In addition, the content selection module 42 selects content suitable for a field in which the visitor is interested. In addition, the content selection module 42 selects content based on the expression of the visitor recognized from the visitor image.

The content selection module 42 may also select not only predetermined attributes but also content corresponding to a plurality of attributes. For example, the content selection module 42 may also select content corresponding to a combination of a plurality of attributes described above.

The content selection module 42 may select one content or multiple content. In the case where multiple content is selected by the content selection module 42, the content display 200 performs numbering so as to display the selected content on the content display 200 in sequence from the content associated with the attribute of the visitor most frequently.

When a plurality of stored visitor attributes exists, the content selection module 42 selects the content associated with the largest number of attributes among the multiple content associated with the plurality of attributes respectively. It should be noted that as the content selected by the content selection module 42, for example, each attribute may be weighted, and the content associated with the attribute having the highest weight among the attributes corresponding to the attributes of the visitor may be selected. In addition, in the case where a plurality of attributes is associated with one content, the content selection module 42 may select the content having the most associated attributes. In addition, in the case where a plurality of attributes is associated with one content, each attribute may be weighted, and the content selection module 42 may select the content associated with the attributes having the largest total weight among the attributes corresponding to the attributes of the visitor.

The content distribution module 23 distributes the selected content to the content display 200 (step S31).

The content reception module 250 receives content distributed by the computer 10. The content display module 270 displays the received content (step S32). In step S32, the content display module 270 displays video, audio and the like based on the received content. The pavilion content changing system 1 displays the content on the content display 200 to display the selected content at the venue of the pavilion. Similarly, in the first content changing processing and the second content changing processing described below, the computer 10 may send an instruction to change the content, and the content display 200 changes the content based on the instruction and displays the changed content.

The above is content display processing.

It should be noted that in the content display processing, configuration of distribution of the content stored in the computer 10 is described, but the content may also be stored in the content display 200. In this case, the computer 10 sends the content display 200 an instruction to display the selected content, and based on the instruction, the content display 200 selects the content to be displayed on the content display 200 itself, and displays the content.

### (First Content Changing Processing)

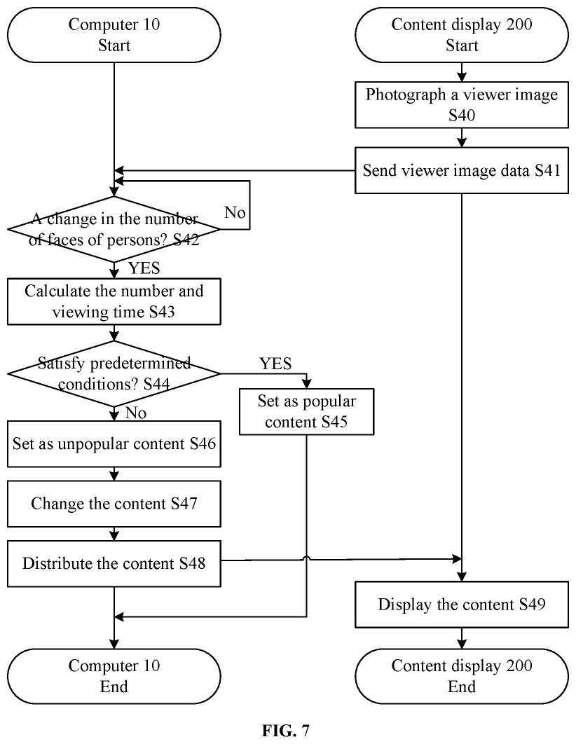

Based on FIG. 7, the first content changing processing performed by the pavilion content changing system 1 is described. FIG. 7 is a flowchart illustrating first content changing processing performed by the computer 10 and the content display 200. Processing performed by the module of each apparatus described above will be described together with the present processing.

The photographing module 271 photographs a viewer image indicating a moving image and a still image of a viewer who is viewing the content (step S40). In step S40, the photographing module 271 photographs the viewer at any time. The photographing module 271 simultaneously acquires the photographing date and time when the viewer image is photographed.

It should be noted that the photographing module 271 may also photograph the viewer at regular intervals (every 30 seconds, every 1 minute, every 2 minutes, etc.).

The viewer image sending module 251 sends viewer image data indicating the viewer image and the photographing date and time to the computer 10 (step S41).

The viewer image reception module 24 receives the viewer image data. The face recognition module 40 performs face recognition of the viewer included in the viewer image by performing image analysis on the viewer image based on the received viewer image data, and analyzes the number of viewers and the viewing time of the viewers (step S42). In step S42, the face recognition module 40 analyzes the viewing time of each viewer when a plurality of viewers views the content from the result of face recognition.

The face recognition module 40 determines, based on the analysis result, whether the face of the viewer or the number of viewers has changed (step S42). In step S42, the face recognition module 40 compares the viewer image data received this time with the viewer image data received so far to determine whether the viewer has changed. The change is, for example, an increase or decrease in the number of viewers, or a difference in all or part of the viewer's face (model, appearance, apparel, etc. of the face).

In step S42, when the face recognition module 40 determines that no change ((NO) in step S42) exists, the face recognition module 40 repeats this processing until a change exists.

On the other hand, in step S42, when the face recognition module 40 determines that a change ((YES) in step S42) exists in step S42, the face recognition module 40 determines that the viewer has moved away from the front of the content display 200, and the viewing situation calculation module 43 calculates the number of viewers who have changed and the viewing time (step S43). In step S43, the viewing situation calculation module 43 calculates the viewing time of a viewer based on the photographing date and time when the viewer who has moved away from the front of the content display 200 was first photographed and the photographing date and time at the time of this change. The viewing situation calculation module 43 calculates the numbers of viewers who have changed and viewers who have not changed as the number of viewers.

The popularity determination module 44 determines whether the number of viewers and the viewing time satisfy predetermined conditions (step S44). In step S44, the popularity determination module 44 determines, for example, whether the number of viewers satisfies a plurality of persons (3 persons, 4 persons, 5 persons, etc.) and whether the viewers' visiting time satisfies predetermined time (5 minutes or more, 10 or more, or more than the time during which the entire substantive content of the content is displayed).

In step S44, in the case where the popularity determination module 44 determines that the predetermined condition is satisfied (YES in step S44), the popularity determination module 44 determines that the content is popular content, and at this time, the content displayed on the content display 200 is set as popular content (step S45). In step S45, the popularity determination module 44 stores the content as popular content in the storage module 30 by assigning an identifier indicating that the content is popular content to the content. Thereafter, when a visitor having an attribute associated with the content distributed this time arrives at the pavilion venue, the content selection module 42 preferentially selects the popular content set in this manner.

On the other hand, in step S44, in the case where the popularity determination module 44 determines that the predetermined condition is not satisfied (NO in step S44), the popularity determination module 44 determines that the content is unpopular content, and at this time, the content displayed on the content display 200 is set as unpopular content (step S46). In step S46, the popularity determination module 44 stores the content as unpopular content in the storage module 30 by assigning an identifier indicating that the content is unpopular content to the content. Thereafter, when a visitor having an attribute associated with the content distributed this time arrives at the pavilion venue, the content selection module 42 does not select the unpopular content set in this manner.

It should be noted that the computer 10 may also delete the unpopular content from the content stored therein. In addition, the computer 10 may also notify the provider of the unpopular content and the pavilion operator that the content is unpopular.

The content changing module 45 changes unpopular content currently displayed on the content display 200 to different content (step S47). In step S47, the content changing module 45 changes the content sent to the content display 200 at this time into different content associated with the attribute associated with this content.

The content distribution module 23 distributes the changed content described above to the content display 200 (step S48).

The content reception module 250 receives content distributed by the computer 10. The content display module 270 changes the currently displayed content into the currently received content and displays the content (step S49). In step S49, even if half of the previously displayed content is displayed, the content display module 270 changes the content to the currently received content and displays the content. The content display module 270 displays video, audio and the like based on the content. The pavilion content changing system 1 changes the content to be displayed on the content display 200 so as to display different content from the content determined to be unpopular.

It should be noted that when a change to different content is made, the content display 200 may display all of the already displayed content, change the content, and display the changed content.

The above is first content changing processing.

### (Second Content Changing Processing)

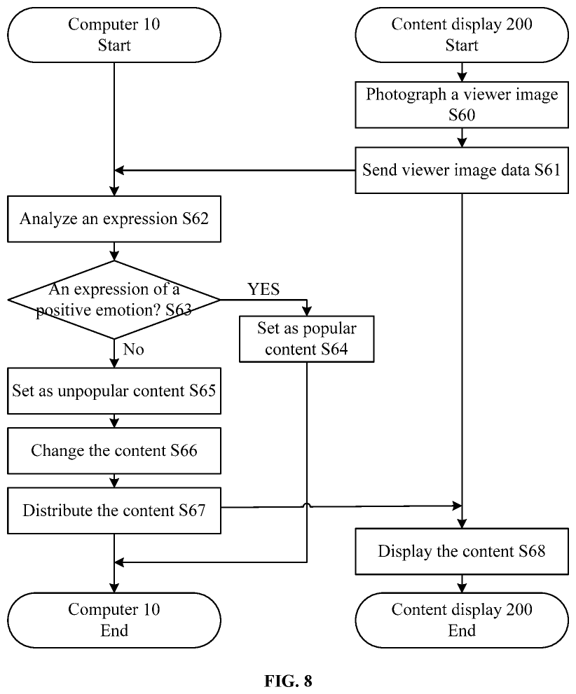

Based on FIG. 8, the first content changing processing performed by the pavilion content changing system 1 is described. FIG. 8 is a flowchart illustrating second content changing processing performed by the computer 10 and the content display 200. Processing performed by the module of each apparatus described above will be described together with the present processing.

The photographing module 271 photographs a viewer image indicating a moving image and a still image of a viewer who is viewing the content (step S60). The processing of step S60 is the same as the processing of step S40 described above, and therefore a detailed description will be omitted.

The viewer image sending module 251 sends viewer image data indicating the viewer image and the photographing date and time to the computer 10 (step S61).

The viewer image reception module 24 receives the viewer image data. The face recognition module 40 performs face recognition of the viewer included in the viewer image by performing image analysis on the viewer image based on the received viewer image data, and analyzes the expression of the viewer (step S62). In step S62, the face recognition module 40 analyzes the expression of each viewer when a plurality of viewers views the content from the result of face recognition.

The face recognition module 40 determines the number of viewers based on the number of faces included in the viewer image. In addition, the face recognition module 40 determines whether the expression of the viewer is an expression of a positive emotion such as happiness, brightness, intoxication, fascination, excitement, earnestness, surprise, laughing and the like, or an expression of a negative emotion such as indifference, restlessness, timidness, fear, doubt, no expression, resignation, displeasure, trouble and the like.

Based on the analysis result, the face recognition module 40 determines whether the expression of the viewer is the expression of the positive emotion (step S63). In step S63, the face recognition module 40 determines whether the expression of the viewer is an expression of a positive emotion or an expression of a negative emotion.

In step S63, in the case where the face recognition module 40 determines that the expression is the expression of the positive emotion (YES in step S63), the popularity determination module 44 determines that the content is popular content, and at this time, the content displayed on the content display 200 is set as the popular content (step S64). The processing of step S64 is the same as the processing of step S45 described above, and therefore a detailed description will be omitted.

On the other hand, in step S63, in the case where the face recognition module 40 determines that the expression is not the expression of the positive emotion (NO in step S63), that is, in the case of the expression of the negative emotion, the popularity determination module 44 determines that the content is unpopular content, and at this time, the content displayed on the content display 200 is set as the unpopular content (step S65). The processing of step S65 is the same as the processing of step S46 described above, and therefore a detailed description will be omitted.

The content changing module 45 changes unpopular content currently displayed on the content display 200 to different content (step S66). The processing of step S66 is the same as the processing of step S47 described above, and therefore a detailed description will be omitted.

The content distribution module 23 distributes the changed content described above to the content display 200 (step S67).

The content reception module 250 receives the content distributed by the computer 10. The content display module 270 changes the currently displayed content into the currently received content and displays the content (step S68). The processing of step S68 is the same as the processing of step S49 described above, and therefore a detailed description will be omitted.

The above is second content changing processing.

The first content changing processing and the second changing processing are described as different processing, but may be one processing. That is, the pavilion content changing system 1 may also determine the popularity of the content based on the number of viewers, viewing time, and the expression.

The above-mentioned units and functions are implemented by a computer (including a CPU, an information processing apparatus, and various terminals) reading and executing a predetermined program. The program may be, for example, provided in a form of Software as a Service (SaaS) provided from the computer via a network. In addition, the program is provided in the form recorded on a computer-readable recording medium such as a floppy disk, a Compact Disc (CD) (including a CD-ROM, etc.), a Digital Versatile Disc (DVD) (including a DVD-ROM, a DVD-RAM, etc.), etc. In this case, the computer reads the program from the recording medium, transmits the program to an internal storage apparatus or an external storage apparatus for storage and execution. In addition, the program may also be pre-recorded on a storage apparatus (recording medium) such as a magnetic disk, an optical disk, a magneto-optical disk, or the like, and is supplied from the storage apparatus to the computer via a communication line.

The embodiments of the present disclosure have been described above, but the present disclosure is not limited to the above-mentioned embodiments. In addition, the effects described in the embodiments of the present disclosure are merely illustrative of the best effects produced by the present disclosure, and the effects of the present disclosure are not limited to the effects described in the embodiments of the present disclosure.

### DESCRIPTION OF REFERENCE NUMERALS

1 Pavilion content changing system, 10 Computer, 100 Entrance terminal, 200 Content display.

1. A computer system for changing content according to an attribute of a visitor in a pavilion, comprising:
a content association unit, which is configured to associate the content with the attribute corresponding to the content;
an acquisition unit, which is configured to acquire the attribute of the visitor;
a selection unit, which is configured to select the content according to an attribute of the content and the attribute of the visitor;
a display unit, which is configured to display the selected content at a venue of the pavilion;
a determination unit, which is configured to determine whether the displayed content is popular; and
a change unit, which is configured to: in response to determining that the displayed content is not popular, change to displaying content different from the displayed content associated with the corresponding attribute;
wherein the attribute of the visitor comprises at least one of: a gender, an age, an occupation, an address, a number of persons accompanying the visitor, a birthplace and a field of interest.

2. The computer system of claim 1, wherein
the acquisition unit is configured to acquire the attribute of the visitor through a preliminary questionnaire.

3. The computer system of claim 1, wherein
the acquisition unit is configured to perform face recognition on the visitor to acquire the attribute of the visitor.

4. The computer system of claim 1, wherein
the selection unit is configured to select content suitable for an occupation of the visitor.

5. The computer system of claim 1, wherein
the selection unit is configured to select content suitable for an age of the visitor.

6. The computer system of claim 1, wherein
the selection unit is configured to select content suitable for a family brought by the visitor.

7. The computer system of claim 1, wherein
the selection unit is configured to select content suitable for a number of visitors in a group.

8. The computer system of claim 1, wherein
the selection unit is configured to select content suitable for a birthplace of the visitor.

9. The computer system of claim 1, wherein
the selection unit is configured to select content suitable for a field in which the visitor is interested.

10. The computer system of claim 1, wherein
the determination unit is configured to analyze an image of viewers who are viewing the displayed content, determine whether the displayed content is popular based on a number of the viewers and viewing time and assign an identifier indicating whether the content is popular content to the content.

11. The computer system of claim 1, wherein
the selection unit is configured to determine an expression of the visitor according to a photographed image of the visitor, and select the content according to the determined expression.

12. A pavilion content changing method for changing content according to an attribute of a visitor in a pavilion, executed by a computer system, comprising:
associating the content with the attribute corresponding to the content;
acquiring the attribute of the visitor;
selecting the content according to an attribute of the content and the attribute of the visitor;
displaying the selected content at a venue of the pavilion;
determining whether the displayed content is popular; and
in response to determining that the displayed content is not popular, changing to displaying content different from the displayed content associated with the corresponding attribute;
wherein the attribute of the visitor comprises at least one of: a gender, an age, an occupation, an address, a number of persons accompanying the visitor, a birthplace and a field of interest.

13. A computer readable program, applied to cause a computer system for changing content according to an attribute of a visitor in a pavilion to perform:
associating the content with the attribute corresponding to the content, wherein the attribute of the visitor comprises at least one of: a gender, an age, an occupation, an address, a number of persons accompanying the visitor, a birthplace and a field of interest:
acquiring the attribute of the visitor;
selecting the content according to an attribute of the content and the attribute of the visitor;
displaying the selected content at a venue of the pavilion;
determining whether the displayed content is popular; and
in response to determining that the displayed content is not popular, changing to displaying content different from the displayed content associated with the corresponding attribute.
